(19) United States
(12) Patent Application Publication
(10) Pub. No.: US 2026/0271956 A1
(43) Pub. Date: Sep. 17, 2026

(54) DARK COCOA POWDERS

(71) Applicant: Cargill, Incorporated, Wayzata, MN (US)

(72) Inventors: Robert Edwin van Temmen, Zaandam (NL); Vincent Schoot Uiterkamp, Haarlem (NL)

(73) Assignee: Cargill, Incorporated, Wayzata, MN (US)

(21) Appl. No.: 18/873,789

(22) PCT Filed: Jun. 28, 2023
(86) PCT No.: PCT/US2023/069213

§ 371 Date: Dec. 11, 2024

(30) Foreign Application Priority Data
Jul. 4, 2022 (EP) 22182737.1

(51) Int. Cl. A23G 1/00; A23G 1/30

(52) U.S. Cl. CPC A23G 1/002; A23G 1/30

(57) ABSTRACT

A process for producing a dark cocoa product is described, comprising the steps of (a) milling a cocoa material in the presence of an aqueous composition; and (b) recovering a dark cocoa product which preferably has an L value below 20 and/or a pH value below 9.0. The dark cocoa product has an “a” value of between 0.5 and 10 and a “b” value of between 0.5 and 10.

### CROSS-REFERENCE TO RELATED APPLICATIONS

This application claims the benefit of EP Priority application Ser. No. 22/182,737.1, filed Jul. 4, 2022, which is incorporated by reference herein in its entirety.

### FIELD

The present invention relates to methods of producing dark cocoa products with improved sensory profiles, to the cocoa products obtainable by these methods, and to food and beverage compositions comprising them.

### BACKGROUND

Cocoa beans are a highly sought-after commodity. Processed to produce cocoa butter, cocoa mass, and cocoa powder, they are used in the manufacture of chocolate, confectionery products (including baked goods such as cookies and cakes), and beverages. Cocoa bean processing typically involves a series of well-established steps designed to enhance the sensory profiles of the final cocoa products. These include fermentation, de-hulling, and roasting of the cocoa beans. A de-hulled cocoa bean is called a cocoa nib. Nibs are crushed and/or milled to produce cocoa liquor (or “cocoa mass”) which, in turn, may be pressed to extract cocoa butter, leaving a substantially defatted cocoa cake (or “press-cake”). The cake can then be more finely ground to produce cocoa powder.

The color and flavor of cocoa powder can be further adjusted through alkalization. Typical alkalization methods are described in U.S. Pat. Nos. 4,435,436, 4,784,866 and 5,009,917, and in European Patent No. 2068641. They usually involve heating cocoa nibs in the presence of an alkalizing agent such as sodium hydroxide or potash, and result in alkalized (or “dutched”) cocoa powders with darker or more intense colors, less acidic flavors and improved water solubility when compared to their non-alkalized equivalents. These darker colors are considered highly desirable and there has therefore been a trend in the industry for more and more intense alkalization, including the production of so-called “black” cocoa powders.

Unfortunately, stronger alkalization can have a detrimental impact on flavor, producing astringent, overly bitter or chemical taste profiles. What's more, the production of black cocoa powders may require the use of undesirable chemicals (such as iron saccharate or ammonium carbonate) that create safety, environmental and regulatory risks. There has therefore been a push to develop dark cocoa powders that have improved flavor profiles and that do not rely on the use of harmful chemicals or over-alkalization.

The color of cocoa powders can be described using the Hunter color coordinate scale or CIE 1976 (CIELAB) color system which uses three coordinates (or values) to define a powder's color profile. The L coordinate represents lightness and can assume values between 0 (for black) and 100 (for white). The L value for non-alkalized cocoa powders is typically 20 or more; between 12 and 20 for slightly alkalized powders; and between 6 and 12 for highly alkalized powders. Cocoa powders described as “black” cocoa powders will typically have an L value of 6 or less.

EP3013153 discloses a method of producing dark-red and dark-brown natural cocoa powders comprising mixing cocoa nibs with water (20% by weight relative to the weight of the nibs), heating the wetted nibs for up to 240 min, and then drying and grinding them. In one embodiment, the nibs are heated to 100° C. at atmospheric pressure. In other embodiment, they are heated to temperatures of 120-140° C. at a pressure of 3 bars. The resulting cocoa powders vary in darkness from an L value of 11.29 to an L value greater than 20 and have a pH of 5.2 to 5.6.

EP3013154 discloses a method of producing a dark-brown natural cocoa powder comprising mixing cocoa nibs with 27-35% water, heating to 89-115° C. for 30 min at pressures of 5-22 psi, and then drying and grinding the product. The resulting powders have an L value of 11.24-14.52 and a pH of 5.4-5.7.

Nevertheless, there remains a need in the industry for a method of producing non-alkalized (natural) or only mildly alkalized dark cocoa powders without the use of undesirable chemicals and with improved flavor profiles.

### STATEMENTS

According to a first aspect of the present invention, there is provided a process for producing a dark cocoa product, comprising the steps of: a. milling a cocoa material, such as cocoa beans or cocoa nibs, in the presence of an aqueous composition; and b. recovering a dark cocoa product.

According to a second aspect of the present invention, there is provided a dark cocoa product obtained by, or obtainable by, the above process. These dark cocoa products will preferably have an L value below 20 and/or a pH value below 9.0.

### SUMMARY

Representative features of the present invention are set out in the following clauses, which stand alone or may be combined, in any combination, with one or more features disclosed in the text of the Specification.

The present invention is as set out in the following clauses:
Clause 1: A process for producing a dark cocoa product, comprising the steps of:
a. milling a cocoa material in the presence of an aqueous composition; and
b. recovering a dark cocoa product.
Clause 2: A process according to clause 1 wherein the cocoa material is selected from cocoa beans, cocoa nibs, cocoa liquor, cocoa cake, cocoa powder, and mixtures of any two or more thereof.
Clause 3: A process according to clause 1 or clause 2, wherein step (a) comprises forming a mixture of a cocoa material and an aqueous composition and milling the resulting mixture.
Clause 4: A process according to clause 3, wherein the cocoa material is mixed with 10-200% by weight aqueous composition, relative to the weight of the cocoa material.
Clause 5: A process according to any one of clauses 3 or 4, wherein the cocoa material is mixed with an aqueous composition having a temperature of 50 to 130° C., more preferably of 60 to 110° C., more preferably of 70 to 100° C., more preferably of 80 to 95° C.
Clause 6: A process according to any one of the preceding clauses, wherein step (a) is performed in an oxygen-rich atmosphere, preferably in the presence of air.
Clause 7: A process according to any one of clauses 3-6, wherein the mixture of cocoa material and aqueous composition has a moisture content of 30-50%.
Clause 8: A process according to any one of the preceding clauses wherein step (a) is performed at a temperature between 50 and 130° C.
Clause 9: A process according to any one of the preceding clauses wherein step (a) is preceded by a step of wet steeping the cocoa material.
Clause 10: A process according to any one of the preceding claims wherein step (b) comprises resting and/or drying the cocoa material.
Clause 11: A process according to any one of the preceding clauses wherein the cocoa material is not an alkalized cocoa material and/or wherein the aqueous composition is substantially free of alkali.
Clause 12: A dark cocoa product obtained by, or obtainable by, the process of any one of the preceding clauses.
Clause 13: A dark cocoa product according to clause 12 which has an L value below 20.
Clause 14: A dark cocoa product according to claim 12 or claim 13 which has a pH value below 9.0.
Clause 15: A dark cocoa product according to any one of claims 12 to 14 which is a natural cocoa product.

### DETAILED DESCRIPTION

As used herein, the words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items. All ranges are inclusive of their limits unless explicitly stated otherwise (thus, for instance, a range of “between A and B” is equivalent to a range of “from A to B”, or of “A-B”, and includes both A and B within the recited range). It must also be noted that as used herein and in the appended claims, the singular forms “a,” “an,” and “the” include plural references unless the context clearly dictates otherwise.

The present invention relates to process for producing a dark cocoa product. The term “cocoa product” as used herein may refer to any product derived from the cocoa bean including, in particular, cocoa nibs, cocoa liquor (or cocoa mass), cocoa cake, and cocoa powder. Preferably the cocoa product will be cocoa powder. The cocoa powder may be of any type known to the skilled person. For instance, it may be a high-fat cocoa powder, with more than 12%, typically about 20-25%, cocoa butter by weight; a standard cocoa powder, with 10-12% cocoa butter by weight; or a low-fat or fat-free cocoa powder, with less than 10% cocoa butter or less than 2% cocoa butter by weight, respectively.

The term “dark” used to describe the cocoa products of the present invention refers to the color of the cocoa product. In particular, it refers to the L value of the cocoa product as defined by the Hunter color coordinate scale or CIE 1976 (CIELAB) color system. A dark cocoa product will thus be a cocoa product with an L value that is preferably less than 20, preferably less than 18, more preferably less than 16, more preferably less than 14, more preferably less than 12, for example between 4 and 20, preferably between 5 and 18, more preferably between 6 and 16. Advantageously, the method of the present invention can be used to produce so-called “black” cocoa products. As used herein, “black” refers to cocoa products with an L value of below 6.

The cocoa product of the present invention will be described in more detail below. It can be obtained from an initial or starting cocoa material by a method as described herein. The cocoa material may be selected from cocoa beans, cocoa nibs (whole or broken), cocoa liquor (or cocoa mass), cocoa cake, cocoa powder (including for example in agglomerated or pelletized form), and mixtures or two or more thereof. It may be (or may be derived from) cocoa beans of any type and any origin which may have undergone any one or more processing steps prior to the method of the present invention. For example, it may be (or may be derived from) cocoa beans with any degree of fermentation (including under-fermented and unfermented beans) which may have been sterilized or not and/or roasted or not. Preferably, the cocoa material will be cocoa nibs. The cocoa material may be an alkalized or non-alkalized cocoa material. Advantageously, the cocoa material will be a natural cocoa material. A natural cocoa material is one that has not been treated with an alkali or alkalizing agent.

The method of the present invention comprises:
milling a cocoa material in the presence of an aqueous composition; and
recovering a dark cocoa product.

### Milling

Milling can be performed using any known milling or grinding method known in the art. Advantageously, the selected milling method will allow oxygen to be incorporated into the material being milled. Thus, milling will preferably be performed using a milling or grinding system that is open to ambient air and/or allows an air-flow to circulate. Examples of suitable milling/grinding methods include the use of stone mills, ball mills and/or roll refiners.

Thus, according to one aspect of the present invention, there is provided a method for producing a dark cocoa product comprising milling a mixture of a cocoa material and an aqueous composition (the “milled mixture”) in an oxygen-rich atmosphere such as air.

During this milling step, the cocoa material will preferably be milled to a particle size of less than 100 μm, more preferably to less than 50 μm, more preferably to less than 40 μm. For example, the cocoa material may be milled at a particle size of greater than 10 μm to 100 μm, preferably to 15-100 μm, more preferably to 20-100 μm, more preferably to 30-100 μm, more preferably to 40-100 μm, more preferably to 50-100 μm, more preferably to 20-90 μm, more preferably to 20-80 μm, more preferably to 20-70 μm, more preferably to 20-60 μm, more preferably to 20-50 μm, more preferably to 20-40 μm.

Milling will advantageously be performed for 15 min to 5 hours. Preferably, it will be performed for 30 min to 4 hours, more preferably for 30 min to 3 hours, more preferably for 30 min to 2 hours. The longer the milling is performed, the darker the final cocoa product will be. However, even after only 30 min, a product can be obtained that is significantly darker than the starting cocoa material.

The milling step is preferably performed at a temperature in the range of 40 to 130° C., more preferably of 40 to 100° C., more preferably of 45 to 80° C., more preferably of 50 to 70° C., more preferably of 50 to 60° C., for example about 55° C. This target temperature can be achieved by the use of a heated aqueous composition as described below.

During the milling step, the temperature of the cocoa material may increase due to friction. Cooling may be used to control the temperature and ensure it stays within the above target temperature ranges. Cooling may be achieved using any method known in the art including, by way of illustration only, through the addition of cold water (or other aqueous composition), by the introduction of an air (or other oxygen-rich gas) flow, or through the use of a cooled or refrigerated jacket on the milling equipment.

### Aqueous Composition

The cocoa material is milled in the presence of an aqueous composition. Any aqueous composition can be used. Preferably, the aqueous composition will be water or an alkali solution.

Alkali solutions are solutions of alkalizing salts in water. Suitable alkalizing salts include ammonium, calcium, magnesium, potassium or sodium carbonate, ammonium, potassium or sodium bicarbonate, ammonium, calcium, magnesium, potassium or sodium hydroxide, magnesium oxide or any combinations of two or more thereof. Preferred alkalizing salts include ammonium carbonate, sodium hydroxide, potassium hydroxide and mixtures of two or more thereof. Alkali solutions will typically have a concentration of alkalizing salts from 0.5% by weight to saturation, preferably from 1 to 25% by weight, more preferably from 2 to 15% by weight, more preferably from 3 to 10% by weight, relative to the total weight of the alkali solution. For example, an alkali solution of 4-9% by weight or of 5-8% may be used, such as an alkali solution of about 6-7% by weight. Advantageously, it has been found that the amount of alkali needed to achieve a certain level of darkness in the final cocoa product is less when using the method of the present invention compared to other methods known in the art. Even more advantageously, it had been found that alkalization can be avoided entirely. As such, the cocoa material will preferably not be wetted with an alkali solution. Instead, it will preferably be wetted with water.

Advantageously, sufficient aqueous composition will be used to substantially fully wet the cocoa material. Thus, an aqueous composition will preferably be added to the cocoa material in an amount of 10-200%, more preferably 15-150%, more preferably 20-100%, more preferably 30-80%, more preferably 40-60%, more preferably about 50% by weight, relative to the weight of the cocoa material.

The aqueous composition may be added to the cocoa material before milling begins (that is prior to the milling step) or after milling has started (during the milling step). It may be added all at once, or in increments. For example, part of the aqueous composition may be added before the milling step, and part may be added during the milling step.

After addition of the aqueous composition, the mixture of cocoa material and aqueous composition will preferably have a moisture content of 10-90%, more preferably of more preferably of 20-80%, more preferably of 30-70%, more preferably of 40-60% by weight.

This moisture content will advantageously be maintained during the milling step, for example by adding further aqueous composition. By way of illustration, further aqueous composition may be added in a single step, at predefined intervals, when a certain minimum moisture content is reached, or continuously throughout the milling step. Alternatively or in addition, the process of the present invention (or at least the milling step) may be performed under conditions of high humidity. For example, it may be performed at a relative humidity of at least 50%, more preferably at least 60%, more preferably at least 70%, more preferably of at least 80%, more preferably at least 90%.

The aqueous composition will preferably be pre-heated prior to addition to the cocoa material. Advantageously, it will be pre-heated to a temperature of 50 to 130° C., more preferably of 60 to 110° C., more preferably of 70 to 100° C., more preferably of 80 to 95° C.

### Oxygen

The milling step is preferably performed in the presence of oxygen. This can be achieved using any method known in the art. For example, the method of the invention may be performed, for at least part of its duration, in an oxygen-rich atmosphere such as air, oxygen-enriched air, ozone, or pure oxygen. In its simplest form, this can be achieved by performing the milling step in an open vessel or in a vessel that is not fully sealed. Preferably, the milling step will be performed on a mill that is open to ambient air and/or allows an air-flow to circulate.

Alternatively (or in addition), an oxygen-rich gas (such as air, oxygen-enriched air, ozone or pure oxygen) may be brought into contact with the cocoa material by pumping it into the mill or directly into the milled cocoa material.

Contact with oxygen may also be achieved by contacting the cocoa material with an oxidizing agent. If using an oxidizing agent, it may be added to the aqueous composition used to wet the cocoa material or added directly to the milled cocoa material. It may be selected from any known oxidizing agents, such as hydrogen peroxide and/or ozone. Preferably the oxidizing agent will be hydrogen peroxide. If used, hydrogen peroxide will preferably be added in an amount of 0.1 to 1% by weight, based on the total weight of the aqueous composition.

Whichever method is used, the cocoa material will preferably be in contact with oxygen for sufficient time to permit the target color to develop.

Advantageously, therefore the process of the present invention comprises the following steps:
(i) mixing a cocoa material with an aqueous composition such as water or an alkali solution, and
(ii) milling the mixture of step (i) in an oxygen-rich atmosphere such as air.

### Pre-Milling Steps

Prior to milling according to the present invention, the cocoa material may optionally be subjected to a wet steeping step. “Wet steeping” as used in the context of the present invention refers to the process of immersing or soaking the cocoa material in an aqueous composition (as defined above) for an extended period of time, preferably for a time sufficient for the cocoa material to become substantially fully wetted. A cocoa material will be “substantially fully wetted” when it has been substantially fully impregnated with an aqueous composition (as opposed, for example, to being only superficially wetted). Thus, for example, when the cocoa material is in the form of cocoa beans or cocoa nibs, the aqueous composition used to wet them will preferably have penetrated to the core of the bean or nib.

In the context of wet steeping, the mixture of cocoa material and aqueous composition will be referred to as a steep mixture, and the equipment used to perform the steeping step will be referred to as a steep tank.

Advantageously, during any wet steeping step(s), the cocoa material will be immersed in sufficient aqueous composition to fully cover it. Alternatively, or in addition, the cocoa material may be agitated during the wet steeping process, for example by manual or mechanical stirring of the steep mixture or by agitation or shaking of the steep tank itself.

Any wet steeping step(s) can (each) last for up to 5 hours. Typically, they will last for 15 min to 5 hours, preferably for 30 min to 4 hours, more preferably for 30 min to 3 hours. They will advantageously be performed at an elevated temperature. For example, any wet steeping step(s) will preferably be performed at temperatures of 80-150° C., more preferably of 90-140° C., more preferably of 100-130° C. Heating can be achieved using any means known in the art, such as a performing the steeping step in a heated steep tank and/or by preheating the aqueous composition before it is added to the cocoa material.

Any wet steeping step(s) will preferably be performed at atmospheric or higher than atmospheric pressures. For example, they may be performed at pressures of 1 to 3 bars. Without wishing to be bound by theory, it is believed that these elevated temperatures and/or pressures promote faster absorption of water into the cocoa material and make the wet steeping process more efficient, allowing shorter wet steeping times to be used.

The wet steeping step(s) may also bring the cocoa material into contact with oxygen, either by being performed in an oxygen-rich atmosphere or through oxygenation (introduction of an oxygen-rich gas flow or addition of an oxidizing agent), all as described above. Preferably, contact with oxygen during any wet steeping step(s) will be achieved by introducing an oxygen-rich gas into the steep mixture, for instance by pumping an oxygen-rich gas (such as air) into a lower portion of the steep tank (below the cocoa material) and allowing it to bubble up through the cocoa material. One way of doing this would be through the use of a fluidized-bed reactor but the skilled person will be familiar with other suitable means. If used, the airflow of oxygen-rich gas through the reactor during the wet steeping step(s), will preferably be 1000 to 10.000 ml/min/kg, more preferably 1000 to 5000 ml/min/kg, more preferably 1000 to 4000 ml/min/kg, more preferably 1000 to 3000 ml/min/kg, more preferably 1000 to 2000 ml/min/kg of cocoa material.

If a wet steeping step is used, any excess aqueous composition remaining at the end of the wet steeping step may be removed prior to the milling step, leaving a wetted cocoa material. Alternatively, the wet steeping mixture may be transferred immediately to the milling step. Thus, the present invention advantageously provides a process for producing a dark cocoa product comprising (a) wetting a cocoa material during a wet steeping step, (b) milling the wetted cocoa material in the presence of an aqueous composition; and (c) recovering a dark cocoa product, wherein step (b) preferably comprises: (i) mixing the wetted cocoa material with an aqueous composition such as water or an alkali solution, and (ii) milling the mixture of step (i) in an oxygen-rich atmosphere such as air.

### Further Processing

After the step of milling the cocoa material, the milled cocoa material may be rested. During resting, the milled cocoa material will preferably be held under anaerobic conditions, for example in a sealed container or vessel, for a period of time sufficient for the target color to fully develop. This may mean a resting time of from 15 min to 5 days, preferably of 30 min to 1 day, more preferably of 1-5 hours. The temperature, during resting, may be allowed to reduce to ambient temperature, or lower (e.g., by refrigeration), or it may be maintained at the milling temperature described above. Advantageously, the cocoa material will be milled and rested.

Thus, the present invention preferably provides a process for producing a dark cocoa product comprising (a) milling a cocoa material in the presence of an aqueous composition; (b) resting the milled cocoa material; and (c) recovering a dark cocoa product, wherein step (b) preferably comprises: (i) mixing the wetted cocoa material with an aqueous composition such as water or an alkali solution, and (ii) milling the mixture of step (i) in an oxygen-rich atmosphere such as air.

After the milling step, and the optional step of resting, the cocoa material will preferably be dried and/or roasted. During drying and/or roasting, the moisture content of the cocoa material is preferably reduced to 10% or less, preferably to 8% or less, more preferably to 7% or less, more preferably to 5% or less, more preferably to 3% or less, more preferably to 2% or less, more preferably to 1% or less.

Drying can be achieved using any technique known in the art. This may include simple air drying at ambient temperature, or drying at elevated temperatures, for example at temperatures in the range of 60 to 90° C. Roasting will preferably be performed at temperatures in the range of 90-150° C., more preferably of 100-140° C., more preferably of 110-130° C. Preferably, the process of the present invention will include a roasting step or a drying step followed by a roasting step.

The cocoa products of the present invention can be used as such, or they may be further processed. For instance, they may be subjected to one or more (further) milling and/or grinding steps to (further) reduce particle size. Alternatively, or in addition, they may be pressed to separate cocoa solids from cocoa butter.

Preferably, cocoa nibs will be used as the starting material for the method of the present invention. They will be milled in the presence of an aqueous composition, and optionally rested, dried and/or roasted as described above. Advantageously, the resulting cocoa mass will then be subjected to a pressing step (to separate and remove cocoa butter from the non-fat cocoa solids), and optionally one or more further grinding or milling steps (including at least one fine grinding step) to produce a cocoa powder. Thus, for example, the method of the present invention may include the following steps:
a) optionally wet steeping a cocoa material
b) milling a mixture of a cocoa material and an aqueous composition in an oxygen-rich atmosphere,
c) optionally resting the resulting cocoa mass,
d) optionally drying and/or roasting the rested cocoa mass,
e) optionally pressing the dried and/or roasted cocoa mass to remove cocoa butter,
f) optionally further grinding the resulting cocoa solids, and
g) recovering a dark cocoa powder.

### Dark Cocoa Products

Accordingly, the present invention also provides dark cocoa products obtained by, or obtainable by, a process as described herein. Cocoa products of the present invention will advantageously have a desirable color profile. The color of cocoa powders can be expressed using the Hunter color coordinate scale or CIE 1976 (CIELAB) color system which uses three coordinates (or values) to define a powder's color profile. The L coordinate represents lightness and can assume values between 0 (for black) and 100 (for white); the a value represents the red/green component (a>0); and the b value represents the yellow/blue component (b>0). The quotient of “a” over “b” represents the redness of the product. Further information on the CIELAB color system can be found, for example, in “Defining and Communicating Color: The CIELAB System” (2013—Sappi Fine Paper North America) and an example of how to measure the L, “a” and “b” values is described under Methodology below.

Cocoa products obtainable by the method of the present invention advantageously have a darker color than their corresponding starting cocoa material. Preferably, they will also have a darker color than a cocoa product obtained from the same starting material and treated under similar conditions but without the wet milling step of the present invention. For example, cocoa products obtained by the method of the present invention will be darker than cocoa products obtained from the same starting material and treated with a same amount of alkali- or with no alkali if none is used in the present invention—for the same amount of time, in the same amount of water, under the same temperature and pressure conditions, but without a milling step.

As used herein, the term “darker” refers to a product having a lower L value than the product to which it is being compared. Preferably, the darker product will have an L value at least 1 point lower, even more preferably at least 2 points lower, than the product to which it is being compared. Advantageously, cocoa products obtainable by the method of the present invention will be “dark” cocoa products, that is cocoa products with an L value of less than 20, preferably less than 18, more preferably less than 16, more preferably less than 14, more preferably less than 12, more preferably less than 10, more preferably less than 8, more preferably less than 6; for example between 2 and 20, preferably between 4 and 15, more preferably between 6 and 10.

Advantageously, cocoa products obtainable by the method of the present invention will have a redder color (i.e. a higher ratio of a/b values) than the starting material, preferably with “a” values that are greater than their “b” values. Advantageously, the cocoa products of the present invention will have a a/b value of 0.5-2, preferably of 0.6 to 1.8, more preferably of 0.7 to 1.6, more preferably of 0.8 to 1.4, more preferably of 0.9 to 1.2.

Preferably, cocoa products obtainable by the method of the present invention will have an “a” value that is lower than the starting material and preferably lower than a corresponding product made from the same starting material but without the milling step of the present invention (as described above). For instance, the “a” value will preferably be at least 0.1 point lower, more preferably at least 0.2 points lower, more preferably at least 0.3 points lower, more preferably at least 0.4 points lower, more preferably at least 0.5 points lower, for example 0.5 to 1 point lower or 0.5 to 2 points lower than that of the product to which it is being compared. Preferably, the “a” value of the cocoa products obtainable according to the method of the present invention will be in the range of 0.5 to 10, preferably 0.6 to 9.0, more preferably 0.7 to 8.0, more preferably 0.8 to 7.0, more preferably 0.9 to 6.0, more preferably 0.5 to 5, more preferably 0.6 to 5, more preferably 0.7 to 5, more preferably 0.8 to 5, more preferably 0.9 to 5.0, more preferably 1.0 to 5.

Advantageously, cocoa products obtainable by the method of the present invention will have a “b” value that is lower than the starting material, and preferably lower than a corresponding product made from the same starting material but without the milling step of the present invention (as described above). For instance, the “b” value will preferably be at least 0.1 point lower, more preferably at least 0.2 points lower, more preferably at least 0.3 points lower, more preferably at least 0.4 points lower, more preferably at least 0.5 points lower than that of the product to which it is being compared. For example, the “b” value may be 0.1 to 2 points lower, preferably 0.2 to 1.8 points lower, more preferably 0.3 to 1.6 points lower, more preferably 0.4 to 1.4 points lower than that of the product to which it is being compared. Preferably, the “b” value of the cocoa products obtainable according to the method of the present invention will be in the range of 0.5 to 10, preferably 0.6 to 9.0, more preferably 0.7 to 8.0, more preferably 0.8 to 7.0, more preferably 0.9 to 6.0, 0.5 to 5, more preferably 0.6 to 5, more preferably 0.7 to 5, more preferably 0.8 to 5, more preferably 0.9 to 5.0, more preferably more preferably 1.0 to 5.0.

Normally, to produce dark cocoa powders like those of the present invention, the degree of alkalization required results in a high pH and an undesirable, alkaline flavor profile. Advantageously, with the method of the present invention, it is possible to produce dark cocoa powders with much lower alkalinity (since no or only mild alkalization is required) and therefore with improved flavor relative to alkalized cocoa powders of equivalent darkness. Thus, the cocoa products of the present invention will advantageously have a pH that is lower than a corresponding product made from the same starting material and with the same L, “a” and “b” values but obtained by traditional alkalization techniques (and without the milling step of the present invention as described above). The cocoa products of the present invention preferably have a pH of 9.0 or less, more preferably of 8.0 or less, more preferably of 7.0 or less, more preferably of 6.5 or less, more preferably of 6.0 or less, for example between 6.0 and 9.0, preferably between 7.0 and 8.0. This results in improved taste relative to highly alkalized cocoa products.

Advantageously, the cocoa products of the present invention will be natural cocoa products. A natural cocoa product is one that has not be treated with alkali. Thus, the present invention advantageously provides dark cocoa products, such as cocoa powders, which have not been treated with alkali.

Thus, in one aspect, the present invention provides cocoa products, such as cocoa powders, which have an L value of less than 20, and a pH of less than 9.0. Preferably, these cocoa products are natural cocoa products. Advantageously, the cocoa products of the present invention may be natural cocoa products. A natural cocoa product is one that has not be treated with alkali or alkalizing agents. Thus, the present invention preferably provides natural cocoa products which have an L value of less than 20; and a pH of less than 9.0.

A further advantage of the present invention is that the cocoa products will have a desirable flavor profile. In particular, they have (i) a less astringent/alkali flavor than alkalized cocoa products with similar color profiles; and or (ii) a more chocolatey or more intense cocoa flavor than other dark cocoa products, including other dark, natural cocoa products. These flavor attributes can be objectively assessed using sensory panels. Sensory panels are a scientific and reproducible method that is essential to the food and beverage industry. A sensory panel involves a group of two or more individual panelists. Panelists are instructed according to industry-recognized practices to avoid the influence of personal subjectivity and to strengthen reproducibility. For example, panelists may objectively evaluate sensory attributes of a tested product but may not provide subjective attributes such as personal preference.

The cocoa products of the present invention, or obtained according to the method of the present invention, can be used on their own or mixed with other cocoa products to produce food and beverage compositions with tailored color and flavor profiles. Advantageously, they can also be used to decrease costs, since smaller quantities can be used to achieve the same color impact as larger quantities of standard cocoa products. Thus, the present invention also provides food and beverage compositions comprising a cocoa product, or obtainable by a method, as described herein. These may include, by way of illustration only, milk, dark, and white chocolate and compound compositions (for use, amongst others, in confectionary, as bars, in truffles and pralines, or as inclusions, coatings, or fillings), drinking chocolate, flavored milks (dairy and non-dairy), flavored syrups, bakery products (such as cakes, cookies and pies), diet bars and meal substitutes, sports and infant nutrition, ice-cream products, dairy products, puddings, mousses, sauces, and breakfast cereals. Methods of manufacturing these food and beverage compositions are also part of the present invention.

Various embodiment of the present invention will now be described by way of the following examples which are provided for illustration purposes only and are not intended to be limiting.

### EXAMPLES

### Method 1—Colour Measurement

All color values measured in the below examples were measured according to the following methodology.

### Instruments and Reagent

Balance correct up to 0.01 gram
100 ml beaker
Stirring rod
Measuring cylinder (25 ml)
Optically neutral petridish (Brand: Sterilin)
Spectrocolorimeter Hunterlab Colorquest, use Illuminant C and 2° standard observer, read values in Hunter L, -a and b values.
Calibration tile black, as present with instrument
Calibration tile white, as present with instrument
Reference cocoa powder sample with known color values
Tap water, temperature range 50-60° C.
Thermometer

### Calibration Procedure

Calibration was done using the black and white calibration tiles provided with the Hunterlab color meter, following manufacturer's instructions.

### Color Measurement Method

5.00±0.01 gram cocoa powder was measured in a 100 ml beaker; 15.0 ml tap water of minimal 50° C. was added to the cocoa powder; the solution was directly stirred until a homogeneous slurry was obtained; the contents of the 100 ml beaker were then cooled to room temperature by letting it rest for 15 minutes; the contents of the beaker were then stirred again and the slurry without lumps was poured into the optically neutral petri dish; the L, a and b-values were then measured on the calibrated color meter—the Hunter L value are recorded to 1 decimal, the a and b values to 2 decimals and the a/b value is calculated and recorded to 2 decimals. Note: after calibration of the color meter, the reference sample was measured first to check matrix fluctuations, followed by non-reference samples.

### Example 1

### Wet Steeping

an IKA conical mixer (CM10) was pre-heated to the 100° C. Two kilos of West African cocoa nibs (from standard fermented beans) were added in the mixer and pre-heated for 30 minutes. 1200 g of hot tap water was then added. The reactor was sealed, and the stirrer turned on at 42 rpm. The process was run for 1 h (without pressure or airflow). A portion of the resulting wet steeped nibs were then subjected to the milling step of the present invention, while the rest was directly dried and roasted in a UNOX 1 convection oven at 130° C. for 1 h 20 min. The resulting nibs had a moisture content below 2% by weight. These were then ground into cocoa liquor and the butter was pressed out to leave cocoa cake, using conventional methods. The cocoa cake was ground into cocoa powder using a Retsch ZM-200 mill with a 0.5 mm sieve.

### Milling Step

600 g of the wet steeped nibs were mixed with 300 g of warm tap water (i.e., water at about 60° C.) and placed in a Premier 1.5 L Tabletop Compact Stone Wet Grinder and milled for 2 hours at 200 watts and 230 Volts, with a speed of 1440 rpm. The resulting product was a high humidity aerated (“fluffy”) mass. It was recovered, spread out into a relatively thin, uniform layer on aluminum baking trays, and roasted in a UNOX 1 convection oven at 130° C. for 2 h 20 min until a moisture content of below 2% was obtained. The resulting material was then further ground into cocoa liquor and the butter was pressed out to leave cocoa cake. The cocoa cake was ground into cocoa powder using a Retsch ZM-200 mill with a 0.5 mm sieve.

The color profiles of the obtained powders were measured using the colour measurement method described above, and are provided in Table 1.

TABLE 1

| | Wet steeped | Wet steeped + Milled |
|---|---|---|
| L | 20.49 | 19.13 |
| a | 10.13 | 9.99 |
| b | 9.85 | 9.34 |
| a/b | 1.03 | 1.07 |

### Example 2

Example 1 was repeated but this time, instead of being mixed with hot tap water during wet steeping, the nibs were mixed with 1200 g of alkali water (Monchique natural alkaline water with a pH of 9.4), preheated to a temperature of 80° C. All other steps and parameters were the same. The properties of the resulting cocoa powders are provided in Table 2.

TABLE 2

| | Wet steeped | Wet steeped + Milled |
|---|---|---|
| PH | 5.78 | 5.77 |
| L | 21 | 18.89 |
| a | 10.57 | 9.54 |
| b | 9.89 | 9.02 |
| a/b | 1.06 | 1.06 |

### Example 3

### Wet Steeping

an IKA conical mixer (CM10) was pre-heated to the 100° C. One kilo of West African cocoa nibs (from standard fermented beans) were added in the mixer and pre-heated for 30 minutes. 1200 g of hot tap water (95° C.) and 80 g of ammonium were then added. The reactor was sealed, and the stirrer turned on at 42 rpm. The process was run for 4 h at ambient pressure conditions (no pressure or air flow added). A portion of the resulting wet steeped nibs were then subjected to the milling step of the present invention, while the rest was roasted and converted to cocoa powder as described in Example 1.

### Milling Step

600 g of the wet steeped nibs were placed in a Premier 1.5 L Tabletop Compact Stone Wet Grinder and milled for 2 hours at 200 watts and 230 Volts, with a speed of 1440 rpm. 300 g of warm tap water (60° C.) was added in steps during the milling (every 30 min). The resulting product was then roasted and converted to cocoa powder as described in Example 1.

The properties of the obtained powders are provided in Table 3.

TABLE 3

| | Wet steeped | Wet steeped + Milled |
|---|---|---|
| Moisture content | 3.60 | 4.6 |
| (% by weight) | | |
| pH | 7.13 | 6.53 |
| L | 9.90 | 7.1 |
| a | 4.90 | 2.5 |
| b | 4.10 | 2 |
| a/b | 1.18 | 1.27 |
| Fat content | 0.50 | 0.7 |
| (% by weight) | | |

### Example 4

### Wet Steeping

an IKA conical mixer (CM10) was pre-heated to the 110° C. Three kilos of West African cocoa nibs (from standard fermented beans) were added in the mixer and pre-heated for 30 minutes. 1200 g of hot tap water (95° C.) and 190 g of KOH (50% w/w) were then added. The reactor was sealed, heated to a temperature of 130° C., set to a pressure of 2.5 bar, and the stirrer turned on at 42 rpm. The process was run for 1 hour, after which the reactor was depressurized and a first sample take (Sample A). The remaining nibs were subjected to a 10 min aeration step with hot air. The reactor was then re-pressurized to 2.5 bar and the wet steeping continued at 130° C. and 42 rpm for a second one-hour period. At the end of the hour, the reactor was depressurized and a second sample taken (Sample B). The aeration, re-pressurization and heating steps were then repeated for a third one-hour period. The reactor was then depressurized and a final sample taken (Sample C). 500 g of the nibs were also recovered at this stage and subjected to the milling step of the present invention. Samples A, B and C, were then roasted and converted to cocoa powder as described in Example 1.

### Milling Step

The 500 g of nibs recovered at the end of the wet steeping step were placed in a Premier 1.5 L Tabletop Compact Stone Wet Grinder with 300 g of warm water (60° C.) and milled for 2 hours at 200 watts and 230 Volts, with a speed of 1440 rpm. The resulting product (Sample D) was then roasted and converted to cocoa powder as described in Example 1.

The properties of the obtained powders are provided in Table 4.

TABLE 4

| | |
|---|---|
| Wet steeped | Wet steeped + Milled |

Sample

| | A | B | C | D |
|---|---|---|---|---|
| pH | 7.54 | 7.23 | 7.06 | 7.04 |
| L | 12.01 | 10.49 | 9.52 | 8.81 |
| a | 8.18 | 6.42 | 5.22 | 4.66 |
| b | 5.08 | 4.07 | 3.36 | 2.95 |
| a/b | 1.61 | 1.57 | 1.55 | 1.58 |

### Example 5

### Wet Steeping

an IKA conical mixer (CM10) was pre-heated to the 110° C. Three kilos of West African cocoa nibs (from standard fermented beans) were added in the mixer. 1200 g of hot tap water (95° C.) and 235 g of K2CO3 (50% w/w) were then added. The reactor was sealed, heated to a temperature of 130° C., set to a pressure of 2.5 bar and the stirrer turned on at 42 rpm. The process was run for 1 hour, after which the reactor was depressurized and a first sample take (Sample A). 600 g of the nibs were also recovered and subjected to the milling step of the present invention. The remaining nibs were subjected to a 10 min aeration step with hot air. The reactor was then re-pressurized to 2.5 bar and the wet steeping continued at 130° C. and 42 rpm for one hour. At the end of the hour, the reactor was depressurized and a second sample taken (Sample B). The aeration, re-pressurization and heating steps were then repeated for a third one-hour period. The reactor was then depressurized and a final sample taken (Sample C). Samples A, B and C, were then roasted and converted to cocoa powder as described in Example 1.

### Milling Step

The partially wet steeped nibs recovered after the first heating step (600 g) were placed in a Premier 1.5 L Tabletop Compact Stone Wet Grinder with 600 g of warm water (60° C.) and milled for 2 hours at 200 watts and 230 Volts, with a speed of 1440 rpm. The resulting product (Sample D) was then roasted and converted to cocoa powder as described in Example 1.

The properties of the obtained powders are provided in Table 5.

TABLE 5

| | |
|---|---|
| Wet steeped | Wet steeped + Milled |

Sample

| | A | B | C | D |
|---|---|---|---|---|
| pH | 8.52 | 8.06 | 7.75 | 7.95 |
| L | 9.52 | 8.12 | 7.49 | 7.32 |
| a | 5.33 | 3.66 | 3.02 | 4.12 |
| b | 3.06 | 2.23 | 1.96 | 2.01 |
| a/b | 1.74 | 1.64 | 1.54 | 2.05 |

### Example 6

### Wet Steeping

an IKA conical mixer (CM10) was pre-heated to the 100° C. One kilo of West African cocoa nibs (from standard fermented beans) were added in the mixer and pre-heated for 30 minutes. 400 g of hot tap water (95° C.), 45 g of sodium hydroxide, 5 g of iron and 35 g of ammonium were then added. The reactor was sealed, and the stirrer turned on at 42 rpm (at 100° C. and ambient pressure). The process was run for a total of 4.5 hours with a sample taken at 4 hours (Sample A) and another at 4.5 hours (Sample B). Samples A and B were then roasted and converted to cocoa powder as described in Example 1.

### Milling Step

600 g of partially wet steeped nibs, recovered at the same time as Sample A, were placed in a Premier 1.5 L Tabletop Compact Stone Wet Grinder and milled for 3.5 hours at 200 watts and 230 Volts, with a speed of 1440 rpm. 450 g of warm water (60° C.) was added in steps, at 30 min intervals, during the milling. The resulting product was dried overnight at 90° C. in a UNOX 1 convection oven and then converted to cocoa powder as described in Example 1 (Sample C).

The properties of the obtained powders are provided in Table 6.

TABLE 6

| | |
|---|---|
| Wet steeped | Wet steeped + Milled |

Sample

| | | |
|---|---|---|
| A | B | C |

| pH | 7.87 | 7.74 | | 7.28 |
|---|---|---|---|---|
| L | 7.37 | 6.90 | | 6.17 |
| a | 1.58 | 1.50 | | 0.78 |
| b | 1.37 | 1.10 | | 0.85 |
| a/b | 1.16 | 1.57 | 1.6 | 0.91 |

### Example 7

### Wet Steeping

an IKA conical mixer (CM10) was pre-heated to the 110° C. Two kilos of West African cocoa nibs (from standard fermented beans) were added in the mixer and pre-heated for 1 hour at 115° C. 1200 g of warm tap water (60° C.) was then added. The reactor was sealed, and the stirrer turned on at 42 rpm. The temperature of the reactor remained at 115° C., the pressure was set to 1.5 bar, and a continuous airflow (at 3 L/min) was introduced through the reactor. After 3 hours, the reactor was depressurized and 500 g of hot water (95° C.) with 80 g of sodium hydroxide were added. The reactor was then re-sealed and wet steeping was continued without pressure or airflow. A portion of the resulting wet steeped nibs were then subjected to the milling step of the present invention, while the rest was roasted and converted to cocoa powder as described in Example 1.

### Milling Step

600 g of wet steeped nibs were placed in a Premier 1.5 L Tabletop Compact Stone Wet Grinder with 350 g of warm water (60° C.) and milled for 1.5 hours at 200 watts and 230 Volts, with a speed of 1440 rpm. The resulting product was then roasted and converted to cocoa powder as described in Example 1.

The properties of the obtained powders are provided in Table 6.

TABLE 7

| | Wet steeped | Wet steeped + Milled |
|---|---|---|
| PH | 8.06 | 8.13 |
| L | 10.13 | 7.81 |
| a | 6.51 | 4.87 |
| b | 3.66 | 2.45 |
| a/b | 1.78 | 1.99 |

1. A process for producing a dark cocoa product, comprising the steps of:
a. milling a cocoa material in the presence of an aqueous composition, wherein the cocoa material is mixed with 10-200% by weight aqueous composition, relative to the weight of the cocoa material to form a mixture; and
b. recovering a dark cocoa product.

2. A process according to claim 1 wherein the cocoa material is selected from cocoa beans, cocoa nibs, cocoa liquor, cocoa cake, cocoa powder, and mixtures of any two or more thereof.

3. A process according to claim 1, wherein step (a) comprises milling the mixture to a particle size of less than 100 μm, more preferably to less than 50 μm, more preferably to less than 40 μm. more preferably from greater than 10 μm to 100 μm.

4. A process according to claim 3, wherein the mixture is milled to a particle size of 20 μm to 100 μm.

5. A process according to claim 1, wherein the cocoa material is mixed with an aqueous composition having a temperature of 50 to 130° C., more preferably of 60 to 110° C., more preferably of 70 to 100° C., more preferably of 80 to 95° C.

6. A process according to claim 1, wherein step (a) is performed in an oxygen-rich atmosphere, preferably in the presence of air.

7. A process according to claim 1, wherein the mixture of cocoa material and aqueous composition has a moisture content of 30-50%.

8. A process according to claim 1, wherein step (a) is performed at a temperature between 5° and 130° C.

9. A process according to any claim 1, wherein step (a) is preceded by a step of wet steeping the cocoa material.

10. A process according to claim 1, wherein step (b) further comprises resting and/or drying the cocoa material.

11. A process according to claim 1, wherein the cocoa material is not an alkalized cocoa material and/or wherein the aqueous composition is substantially free of alkali.

12. A dark cocoa product obtained by, or obtainable by, the process of claim 1.

13. A dark cocoa product according to claim 12 which has an L value below 20.

14. A dark cocoa product according to claim 12 which has a pH value below 9.0.

15. A dark cocoa product according to claim 12, which is a natural cocoa product.

16. A dark cocoa product according to claim 12, which has an “a” value in the range of 0.5 to 10, preferably 0.6 to 9.0, more preferably 0.7 to 8.0, more preferably 0.8 to 7.0, more preferably 0.9 to 6.0, more preferably 1.0 to 5.

17. A dark cocoa product according to claim 12, which has a “b” value in the range of 0.5 to 10, preferably 0.6 to 9.0, more preferably 0.7 to 8.0, more preferably 0.8 to 7.0, more preferably 0.9 to 6.0, more preferably 1.0 to 5.

18. A dark cocoa product according to claim 12, which has an “a” value and a “b” value that are lower than a starting material and preferably lower than a corresponding product made from the starting material but without the milling step.
